(19) United States
(12) Patent Application Publication
(10) Pub. No.: US 2021/0409061 A1
(43) Pub. Date: Dec. 30, 2021

(54) FORWARD ERROR CORRECTION

(71) Applicant: Mano D Judd, Heath, TX (US)

(72) Inventor: Mano D Judd, Heath, TX (US)

(21) Appl. No.: 16/916,346

(22) Filed: Jun. 30, 2020

(51) Int. Cl. H04B 1/40

(52) U.S. Cl. CPC H04B 1/40

(57) ABSTRACT

The Forward Error Correction (FEC) technique completely estimates the total path length, time delays, as well as amplitude values and variations for the full path between the RF exciters and antennas, in an RF Phased Array System. These paths are normally unknown and therefore difficult to calibrate. The technique also corrects for phase and amplitude differences and variations in non-equal length RF cables, thus removing the requirement for phase matched cables in the array system.

The present application claims priority to the earlier filed provisional application having Ser. No. 62/872,420, and hereby incorporates subject matter of the provisional application in its entirety.

### BACKGROUND

In many RF Array Systems, especially ones with very large or dispersed arrays such as the Low Frequency arrays, Phase Matching of RF cables to assure RF coherency and beam steering ability is required. This is due to the requirement that each channel path from each array antenna to its receiver or transceiver must be exactly equal. This therefore incurs substantial additive costs for the procurement or fabrication of phased matched cables or equal length corporate feeds to the multiplicity of array antennas. For an airborne system, required use of RF phased matched cables not only adds system cost, but generates much additional weight and volume for the collection of equal length cables. That is, while the distance from one antenna to the receiver or transceiver system may be short, its cable needs to be the same length as the cable used for the antenna furthest from the transceiver system.

Another problem is that unknown and/or unpredictable phase and/or amplitude changes or perturbations, due to temperature changes within active components and even passive devices and transmission lines (e.g. RF cables), can produce large errors in the system performance.

In most receive and especially transmit systems, these perturbations and/or distortions are typically not addressed or compensated for.

### BRIEF SUMMARY OF THE INVENTION

The Forward Error Correction (FEC) technique completely estimates the total path length, time delay, as well as amplitude value(s) for the full path between the RF Exciter and the Antenna. These paths (lengths, or delay times) are firstly unknown, difficult to calibrate, and can change from product lot to lot as well as vary across temperature and time. Thus, while the FEC technique corrects for all phase and amplitude variations and changes in the system, it also corrects for phase and/or amplitude differences in non-equal length RF cables, removing any requirement for phased matched cables in the array system. This is a very powerful benefit.

### BRIEF DESCRIPTION OF THE DRAWINGS

FIG. 1 shows the block diagram of a conventional Phased Array channel.

FIG. 2 shows a similar block diagram, however, the RF switch at the antenna has been replaced by an RF Circulator.

FIG. 3 shows the Inventor's circuit representation for the full Analog/RF embodiment of the FEC technique.

FIG. 4 shows the collection of all independent paths in the full system.

FIG. 5 shows the Receive Path.

FIG. 6 shows the Bore Inner Source Path.

FIG. 7 shows the Bore Inner Exciter Path

FIG. 8 shows the Bore Outer Source Path.

FIG. 9 shows the Bore Outer Exciter Path.

FIG. 10 shows the Bore Outer Exciter Path.

### DETAILED DESCRIPTION AND BEST MODE OF IMPLEMENTATION

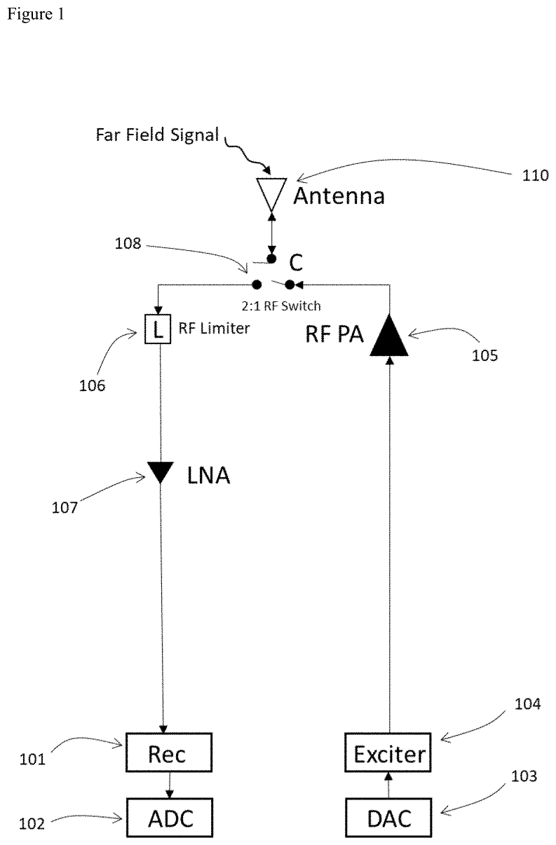

FIG. 1 shows the block diagram of a conventional Phased Array channel, consisting of a transmitter section, composed of a Digital to Analog Converter (DAC), (103), feeding the (Digital to RF) Exciter (104), and the RF Receiver (101) feeding the Analog to Digital Converter (ADC), (102). Towards the (channel) antenna is an RF Power Amplifier (RF PA), (105), connecting to a 2:1 RF Switch (108). One side of the switch connects the Antenna (path), (110), to the RF PA (105), which is the transmit path, and the other side of the switch connects the Antenna (110) to the Receiver path (101). Often in the receive path, following the antenna, is an RF Limiter (106), which limits the [often destructive] high power RF from damaging the following components, such as the Low Noise Amplifier (LNA), (107), or the RF Receiver (101), shown. Using the RF Switch (108), at the Antenna, this system would only be half duplex, since it could not Transmit and Receive at the same time. However, this system allows greater isolation from the Transmit port to the Receive port, adding extra RF power protection to the receive circuitry.

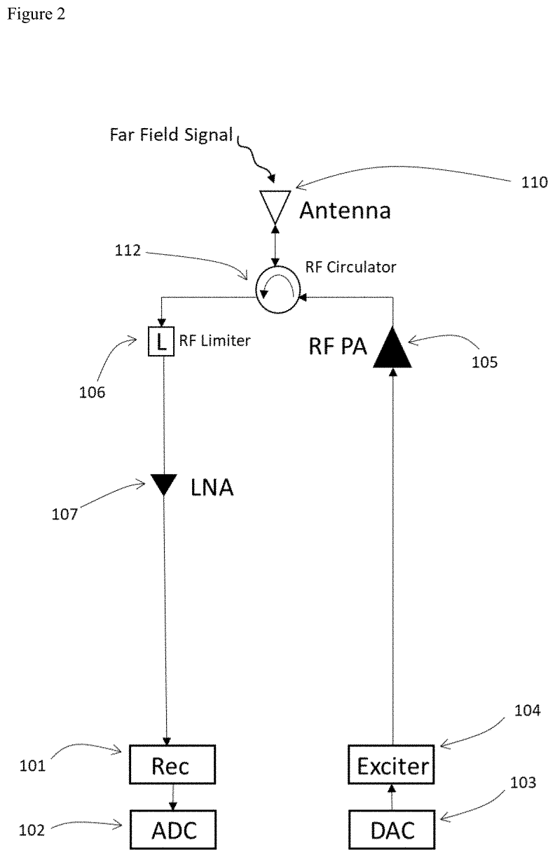

FIG. 2 shows a similar block diagram, however, the RF switch (108) at the antenna (100) has been replaced by an RF Circulator (112). The Circulator (112) enables full duplex; for the system to receive signals at the same time the transmission path is generating and transmitting signals. However, most Circulators are very band limited and only provide roughly 20 to 40 dB of isolation between the transmitter and receiver ports. For the sake of completeness, either switch (108) or circulator (112) can be used in all following designs, configurations, and embodiments. However, the remainder of this document will use the RF Switch (108) configuration, since it lends greater applicability to wideband use and wideband systems.

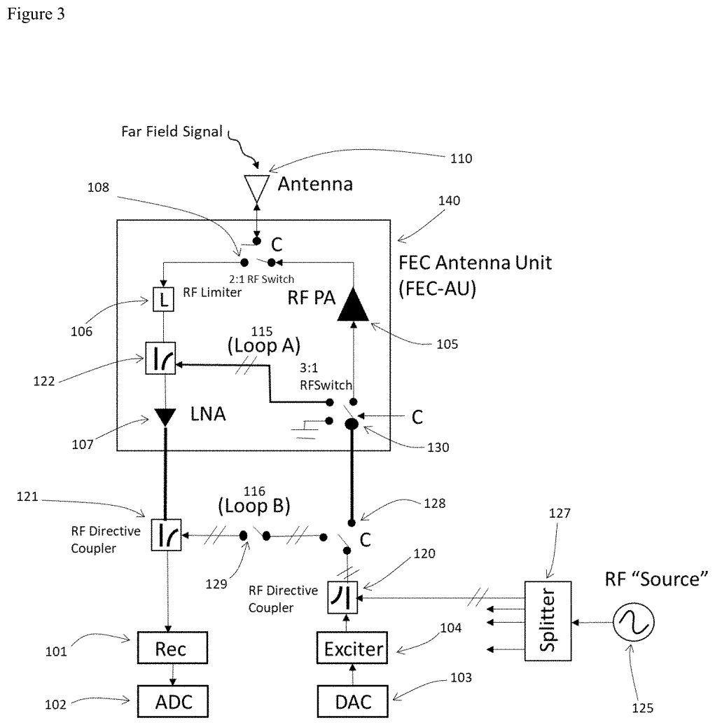

FIG. 3 shows the Inventor's circuit representation for the full Analog/RF embodiment of the FEC technique. Two critical loops, A (115) and B (116), have been added to the system of FIG. 1, as well as a collection of RF couplers (120, 121, 122), and an independent/external RF source. The square at the top represents system RF components that are located at or close to the Antenna. The components within this box are collectively denoted as the FEC Antenna Unit (FEC-AU), (140).

Each channel of the Exciter system (104) can generate a signal (source). These sources, for each independent transceiver/receiver channel, are designated as “Exciter”. The External Source (125), denoted simple as “Source”, is copied through an RF Splitter (127) where each split component of the source is fed and coupled (120) to the Exciter (104) output, for each channel. The two loops provide for signaling paths, that are used to compute and calibrate each path (length) segment of the full system.

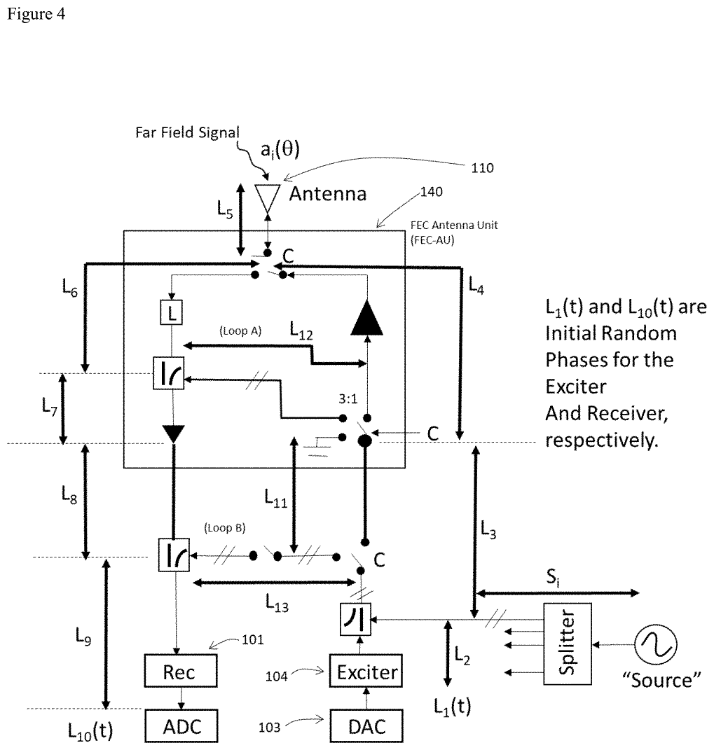

FIG. 4 shows the collection of all independent paths in the full system. Each path represents a length of travel, and therefore a finite time delay of a signal along each path. Note, it is assumed that many of these paths are not time-stationary, and could change due to temperature effects, or where for example a cable or component may be replaced in the field due to damage or failure. Thus, it is not assumed that the replacement component will have the same effect path length nor time delay as the previous component. In fact, as will be shown, the FEC system and technology completely compensates for this resultant, and will calibrate out the time delay difference between the old component and the new component. Therefore, most of the vast many paths, L₁ through L₁₃, can all be estimated in real time. Note however, that a few paths, composed of PC Board traces, would be treated as constant and not varying over time, or from a component change-out, since PCB tolerances are very high.

Two of the most important, yet subtle components of this configuration are path lengths (time delays) L₈ and L₁₁. These two components represent RF transmission lines, or cables from the Exciter & Receiver system to the channel antenna. In many past systems, to control or know the phase delay, all the L₈ and L₁₁ cables or other transmission line were fabricated and verified as RF Phased Matched. That is, each and every cable would be the same length. As mentioned in the Background Section, this solution is both expensive and often winds up having many cables that are rolled up, which increases system size and weight. Thus, while the FEC technique corrects for all phase and amplitude variations and changes in the system, it also corrects for non-equal length RF cables. This is a very powerful benefit.

Let

t₁=time of calibration operation

t₂=time of beamformer operation.

t₂, t₃, . . . , tₖ are sequential beamformer (operation) times, to boresight various paths. It should be noted that the initial time of full system calibration, t₁, can be very different (days to years) prior to the beamformer operation time, t₂. However, since the initial random phase of each channel is very stationary during the time interval from t₂ to tₖ, and that it is assumed that the transceiver has not been reset or frequencies changed during this time interval then, effectively:

L₁(t₂)=L₁(t₃)=L₁(t₄)= . . . L₁(tₖ).

Similarly, it can be assumed that:

L₁₀(t₂)=L₁₀(t₃)=L₁₀(t₄)= . . . L₁₀(tₖ).

However, it is not assumed that:

L₁(t₁)=L₁(t₂) or that L₁₀(t₁)=L₁₀(t₁).

Or stated more clearly:

L₁(t₁)≠L₁(t₂) and L₁₀(t₁)≠L₁₀(t₁).

For some systems, it can also be assumed that this stationarity might only be over a short time interval, say 10 to 60 seconds, due to active devices changing phase as they heat up or cool down, or due to any component aging effects. Thus, FEC calibration updates would likely need to be repeated every second or couple of seconds. This would mean that during system or beamformer operation times, t₂ through tₖ, that FEC re-calibration would be repeated constantly; e.g. every few seconds.

The goal of this [FEC] process is to estimate the true beamformed path of the signal, in the transmit direction.

$$Transmit Path = {e}^{j \frac{ω}{c} ( {L}_{1} ( {t}_{2} ) + {L}_{2} + {L}_{3} + {L}_{4} + {L}_{5} + {a}_{i} ( θ ) )} = {e}^{j \frac{ω}{c} ( Δ {L}_{T P} ( {t}_{2} ) + {a}_{i} ( θ ) )}$$

Where:

aᵢ(θ) represents the path from a point in the far field, to an antenna i, and at θ degrees.

and ΔL_{TP}(t₂)=L₁(t₂)+L₂+L₃+L₄+L₅

This represents the net path (distance) delays from the Digital to Analog Converter (DAC), (103), through the exciter (104) and up through the antenna (110), for the complete RF system. This also includes any random initial phase (length), L₁(t₂), in the exciter (104). Therefore, each beamformed correction weight can be represented as:

$$\underline{w} = {e}^{j \frac{ω}{c} ( Δ {L}_{T P} ( {t}_{2} ) + {a}_{i} ( θ ) )}$$

Where the expression on the right is assumed to be a unique weight for each independent transmit channel, i. Prior to FEC system calibration and boresighting, this total path length (weight) is firmly unknown. Since internal DAC (103) and Exciter (104) PCB paths lengths are typically unknown, and can be different from channel to channel, and the RF PA (105) can have a phase change in both time and across frequency while heating up, there really is no known method to estimate and compensate for the various path lengths Lᵢ. These must be measured.

During operation, if a coherent signal is transmitted, from each antenna element i=1, 2, . . . , M, it can be beamformed to a point in the Far Field, using:

$${\underline{w}}^{*} \cdot {e}^{j \frac{ω}{c} ( Δ {L}_{T P} ( {t}_{2} ) + {a}_{i} ( θ , f ) )} = M$$

The ultimate goal of the FEC process is to produce a set of weights for each frequency, such that with knowledge of the far field steering vector, aᵢ(θ, f), that transmission can be effectively emulated from an exact planar array with phased matched cables to each antenna (110). The FEC method, in fact does not require the use of any phase matched cables from the Exciter(s) (104), to the FEC Antenna Unit (FEC-AU), (140), nor any phased matched cabled from the FEC-AU (140) to the Receiver(s) (101).

One requirement of the FEC technique is the generation of the receive system response, which is also termed the ‘Array Manifold” in many published documents. However, most publications only include the path from the far field source to each antenna (110). The true Array Manifold, or system steering vectors will not only include the far field steering vector, aᵢ(θ, f), but will also include any and all paths lengths up to and through each channel ADC (102).

Therefore, the signal transmitted from a far field calibration source is received and the System steering vector for the i^{th} antenna or channel can be presented as:

$$Receive Path ( {t}_{1} ) = {e}^{j \frac{ω}{c} ( {a}_{i} ( θ ) + {L}_{5} + {L}_{6} + {L}_{7} + {L}_{8} + {L}_{9} + {L}_{10} ( {t}_{1} ) )}$$

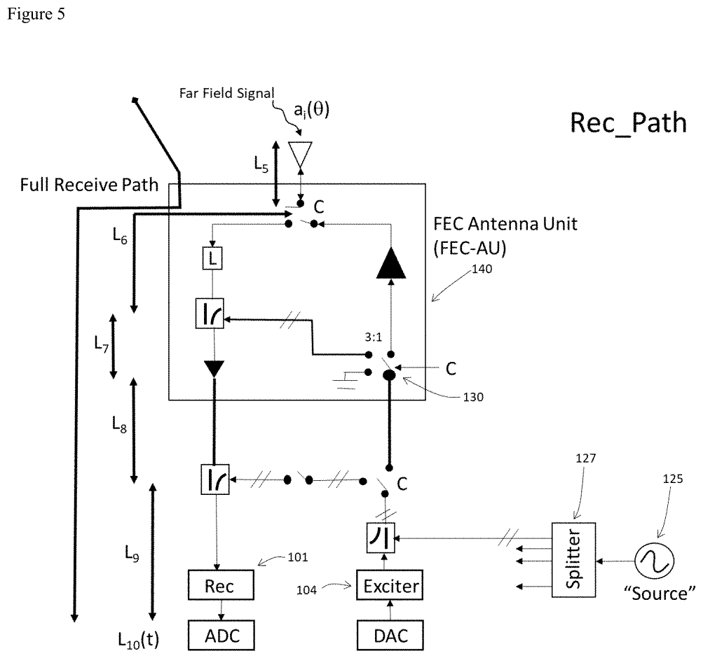

This is shown more clearly in FIG. 5.

The Receive Path (Boresighting) is performed at time t₁. This could be days, weeks, months, or even years from when the actual system is used in operation, and thus FEC Boresighting (calibration) is performed. This receive path calibration, at time t₁, is therefore used to obtain the Total Effective Steering Vectors (e.g. Array Manifold) for the system. This would be the same steering vectors that would be stored for a Direction Finding application.

There are four possible boresight paths, enabled within the current system, which all go through the FEC Antenna Unit (FEC-AU), (140):

1. Bore Inner Source:

$${B}_{inner , source} ( {t}_{i} ) = {e}^{j \frac{ω}{c} ( {S}_{1} + {L}_{3} + {L}_{12} + {L}_{7} + {L}_{8} + {L}_{9} + {L}_{10} ( {t}_{i} ) )}$$

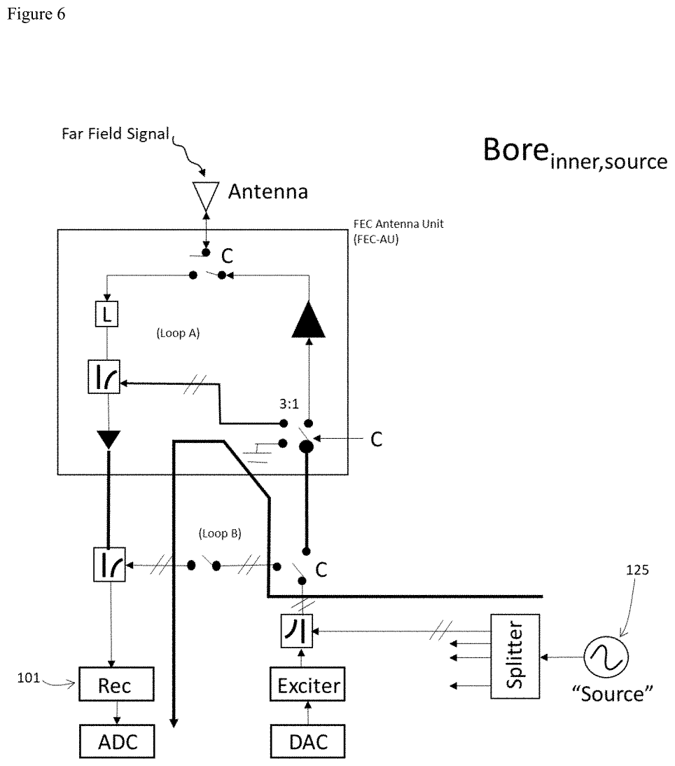

This Path is shown in FIG. 6.

2. Bore Inner Exciter:

$${B}_{inner , exc} ( {t}_{i} ) = {e}^{j \frac{ω}{c} ( {L}_{1} ( {t}_{i} ) + {L}_{2} + {L}_{3} + {L}_{12} + {L}_{7} + {L}_{8} + {L}_{9} + {L}_{10} ( {t}_{i} ) )}$$

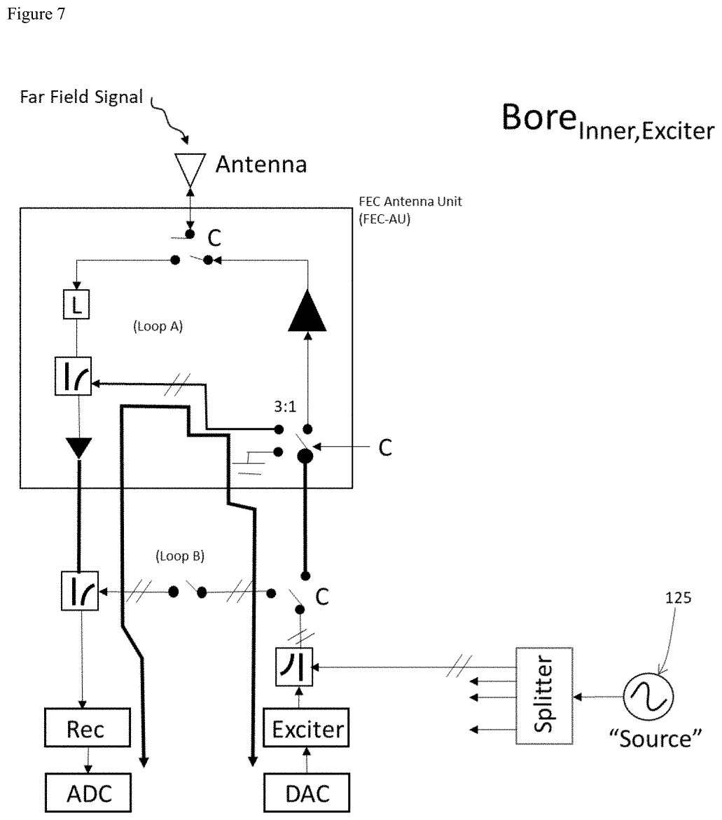

This Path is shown in FIG. 7.

3. Bore Outer Source:

$${B}_{outer , source} ( {t}_{i} ) = {e}^{j \frac{ω}{c} ( {S}_{1} + {L}_{3} + {L}_{4} + {L}_{6} + {L}_{7} + {L}_{8} + {L}_{9} + {L}_{10} ( {t}_{i} ) )}$$

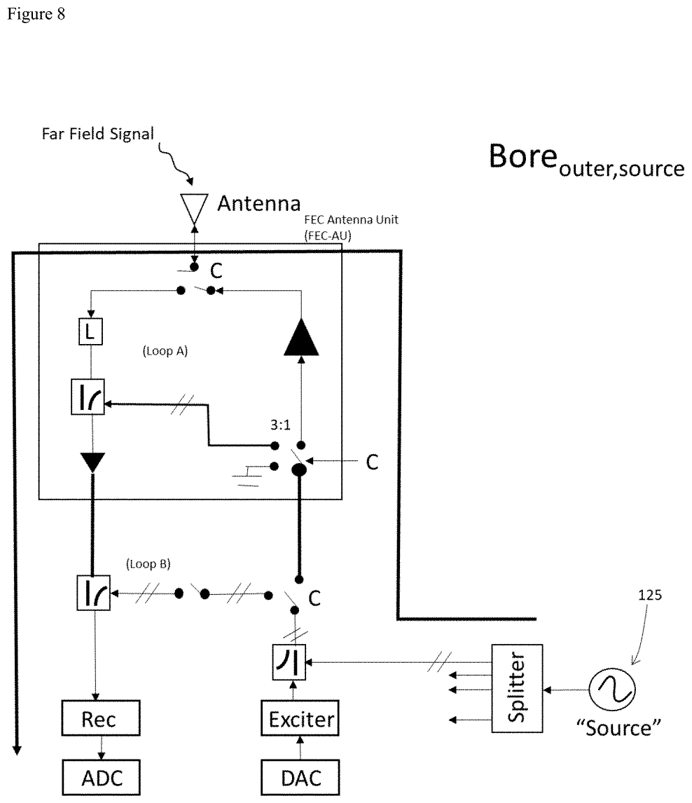

This Path is shown in FIG. 8.

4. Bore Outer Exciter:

$${B}_{outer , exc} ( {t}_{i} ) = {e}^{j \frac{ω}{c} ( {L}_{1} ( {t}_{i} ) + {L}_{2} + {L}_{3} + {L}_{4} + {L}_{6} + {L}_{7} + {L}_{8} + {L}_{9} + {L}_{10} ( {t}_{i} ) )}$$

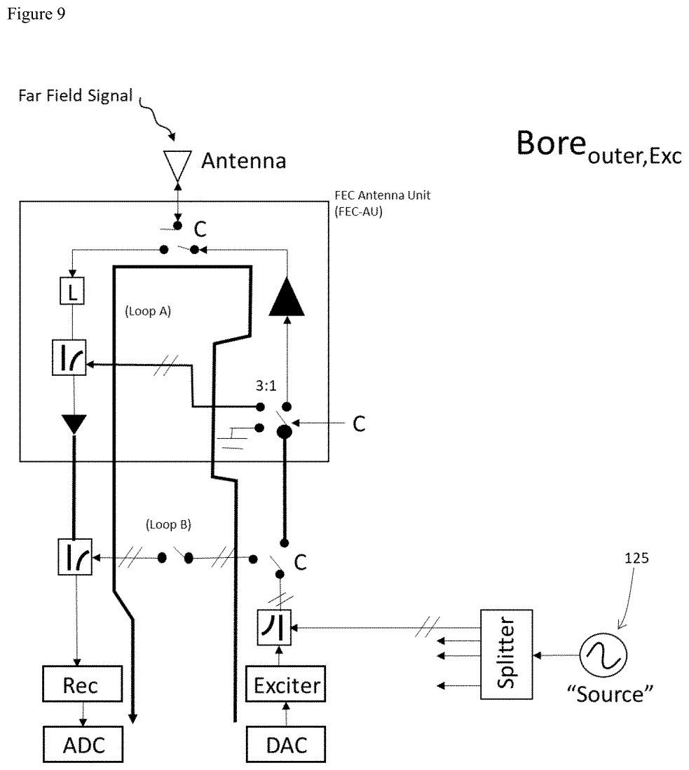

This Path is shown in FIG. 9.

The time tᵢ for each of these four (4) paths, can be (measured) anytime at t₂ or afterwards. Additionally, these four (4) paths do not have to be measured in any particular order, but do need to be performed within a time period as close to each other as possible.

The first word, “Bore” simply represents a measurement. That is, a bore-sighting measurement in which the particular boresight vector is computed through sampling of the representative path, and integrating samples to produce an averaged vector resultant. This vector is obtained through collection of channel time samples, formation of a sampled covariance matrix, decomposition, and selection of the eigenvector associated with the dominant eigenvalue.

The words “Inner” and “Outer” refer to the particular loop path chosen. For example, the Inner path would use L₁₂, and the Outer path would use L₄+L₆ (as shown in FIG. 4). These two paths are selected in the 3:1 RF Switch (130) at the bottom right of the FEC-AU box (140). Source (125) and Exciter (104) are chosen based on which RF source is selected. It could be assumed that for Sᵢ values, that for each Sᵢ(t), it is assumed that the External Source (125) and RF Splitter (127) is connected to the RF Exciter (104) Channels with equal length (PCB) transmission lines. That is, that the full External Source (125), RF Splitter (127), and Transmission lines comprising Sᵢ different paths (i=1, . . . , M) are all designed as equal length PCB traces. However, even if these paths are slightly different, it will not affect the results. This will be proven later. Thus, the Sᵢ paths, one for each channel, do not have to be phased matched.

During the calibration receive phase, during time t₁, the system receives two signals:

$$Receive Path ( {t}_{1} ) = {e}^{j \frac{ω}{c} ( {a}_{i} ( θ ) + {L}_{5} + {L}_{6} + {L}_{7} + {L}_{8} + {L}_{9} + {L}_{10} ( {t}_{1} ) )} and$$

$${B}_{inner , source} ( {t}_{1} ) = {e}^{j \frac{ω}{c} ( {S}_{1} + {L}_{3} + {L}_{12} + {L}_{7} + {L}_{8} + {L}_{9} + {L}_{10} ( {t}_{1} ) )}$$

These two values are taken at exactly the same time, and use either snapshot-by-snapshot boresighting or covariance boresighting. This process is covered in the Inventor's patent Ser. No. 10/185,022. The resultant is then to generate, via unwrapping and phase & amplitude interpolation, a calibration table (or array manifold), which includes the boresighted correction phases. This cal table can be denoted as:

$${a}_{c a l , i} ( θ ) = \frac{\begin{matrix}Receive \\ Path ( {t}_{1} )\end{matrix}}{{B}_{inner , source} ( {t}_{1} )} = \frac{{e}^{j \frac{ω}{c} ( \begin{matrix}{a}_{i} ( θ ) + {L}_{5} + {L}_{6} + \\ {L}_{7} + {L}_{8} + {L}_{9} + {L}_{10} ( {t}_{1} )\end{matrix} )}}{{e}^{j \frac{ω}{c} ( \begin{matrix}{S}_{1} + {L}_{3} + {L}_{12} + {L}_{7} + \\ {L}_{8} + {L}_{9} + {L}_{10} ( {t}_{1} )\end{matrix} )}} = \frac{{e}^{j \frac{ω}{c} ( \begin{matrix}{a}_{i} ( θ ) + \\ {L}_{5} + {L}_{6}\end{matrix} )}}{{e}^{\frac{ω}{c} ( \begin{matrix}{S}_{1} + {L}_{3} + \\ {L}_{12}\end{matrix} )}}$$

It should be noted, that L₃, L₅, L₆, and L₁₂ are unknown values, and since we are not relying on any cable or transmission line phase matching, their exact time-lengths cannot be reliably estimated prior to system integration.

Additionally, as mentioned prior, the values of L₆ and L₁₂ will be assumed to be extremely equivalent, from channel to channel, since these paths will be (repeatable) lengths on a PC board.

A fundamental assumption for FEC is that manufacturing repeatability and tolerances (accuracy) can be held to under 0.1 mil error in current PCB design and fabrication. At even 10 GHz carrier frequency, where the wavelength is 0.03 meters (1.18 inches), this represents an error of 0.000084 times (or 0.1×0.001″/1.18″). In phase degrees, this would be:

Phase error=k*length error (radians)

=(2*pi/lamda)*(0.1×0.001″)

=(2*pi/1.18″)*(0.0001″)

=0.0005 radians

=0.0305 electrical degrees

Thus, even at 10 GHz, this represents an extremely small (phase) error.

Therefore, since values of L₆ and L₁₂ will can be assumed exactly equivalent from channel to channel, then:

$${a}_{c a l , i} ( θ ) = \frac{{e}^{j \frac{ω}{c} ( {a}_{i} ( θ ) + {L}_{5} )}}{{e}^{j \frac{ω}{c} ( {S}_{1} + {L}_{3} )}} = {e}^{j \frac{ω}{c} [ {a}_{i} ( θ ) + {L}_{5} - {L}_{3} - {S}_{1} ]}$$

Using this novel forward correction circuitry and algorithms, it is now possible to ultimately calibrate out all unknown paths, and solve for the true forward path.

To obtain L₁(tᵢ)+L₂:

$${B}_{inner , source} ( {t}_{2} ) \cdot {( {B}_{inner , exc} ( {t}_{2} ) )}^{*} = {e}^{j \frac{ω}{c} ( {S}_{1} - {L}_{1} ( {t}_{2} ) - {L}_{2} )} {or \\ ( {B}_{i n ner , sou r c e} ( {t}_{2} ) )}^{*} \cdot {B}_{inner , exc} ( {t}_{2} ) = {e}^{j \frac{ω}{c} ( {L}_{1} ( {t}_{2} ) + {L}_{2} - {S}_{1} )}$$

To obtain L₃, there are two methods. The first is denoted as the Direct Measure Method.

Direct Measure Method:

Currently, the length of long (coax) cables L₃ are unknown.

One method to obtain L₃ is simply to connect the end of the L₃ cable (at the FEC-AU) directly to the receiver (101); and use the source (125). This measurement gives us:

$${B}_{with L 3} ( {t}_{i} ) = {e}^{j \frac{ω}{c} ( {S}_{1} ( {t}_{i} ) + {L}_{3} + {L}_{8} + {L}_{9} + {L}_{10} ( {t}_{i} ) )}$$

Next, connect the source (125) directly to the receiver (101), omitting cable L₃. This measurement gives:

$${B}_{without L 3} ( {t}_{i} ) = {e}^{j \frac{ω}{c} ( {S}_{1} ( {t}_{i} ) + {L}_{8} + {L}_{9} + {L}_{10} ( {t}_{i} ) )}$$

Conjugate multiplication of these two vectors, results in:

$${B}_{j} = {B}_{with L 3} ( {t}_{i} ) \cdot ( {( {B}_{without L 3} ( {t}_{i} ) )}^{*} = {e}^{j \frac{ω}{c} ( L 3 )}$$

The disadvantage of this method is that it needs to be repeated if a cable (L3) fails and needs to be replaced. However, the complete process still negates the need for phased matched cables.

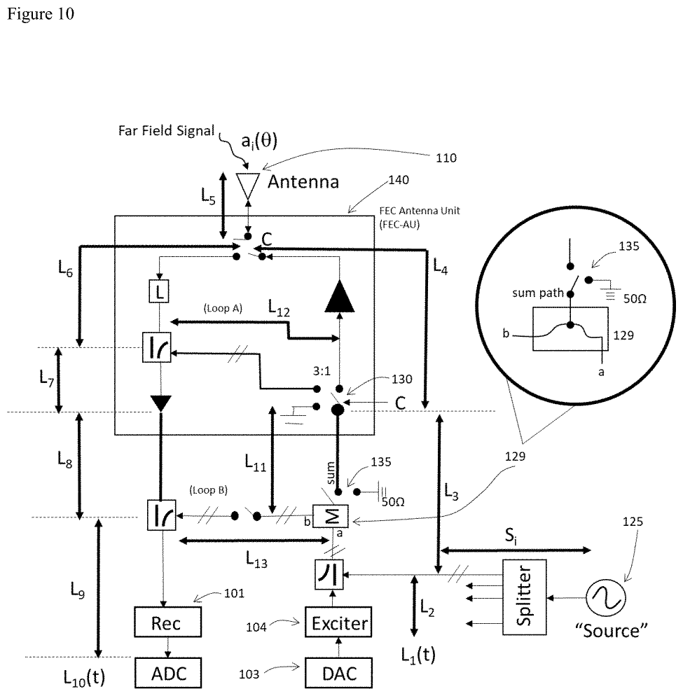

The second method is the Reflectometry Method. In this method we inject a source (125) signal with the 3:1 switch (130) set to the “short” position. This reflects a signal which is measured at the receiver (101). The switch (128) is now replaced by a 2:1 RF summer (129), and a different 2:1 switch with 50Ω termination on one switch port, shown in FIG. 10.

The 2 L₁₁ path difference is measured through L₁₃. Then the 2:1 switch (130) is thrown, which terminates the sum port path, and another measurement is performed. Subtraction of these two vectors gives 2 times L₁₁.

To get L₃, use the TDR method to obtain L₁₁

$$T D {R}_{source} ( {t}_{2} ) = {e}^{j \frac{ω}{c} ( {S}_{1} + {L}_{11} )}$$

However,

$${e}^{j \frac{ω}{c} ( {L}_{11} )} \approx {e}^{j \frac{ω}{c} ( {L}_{3} )}$$

Since the lengths within each coupler, on the PCB, should be equivalent from channel to channel. Note that L₃ includes the length of the coupler.

Therefore:

$$T D {R}_{source} ( {t}_{2} ) \approx {e}^{j \frac{ω}{c} ( {S}_{1} + {L}_{3} )}$$

This should be the same as:

$$T D {R}_{source} ( {t}_{1} ) \approx T D {R}_{source} ( {t}_{2} ) \approx {e}^{j \frac{ω}{c} ( {S}_{1} + {L}_{3} )}$$

Both of the conventional methods to obtain L₃, obtain the same results as the TDR method, thus:

$${B}_{j} \approx T D {R}_{source} ( {t}_{2} ) \approx {e}^{j \frac{ω}{c} ( {S}_{1} + {L}_{3} )}$$

However, the TDR method is automated, quicker, and allows for change outs of new cables, without the need for physical re-calibration.

To get L₄, using the source only, is:

$${B}_{inner , source} ( {t}_{2} ) \cdot {( {B}_{outer , source} ( {t}_{2} ) )}^{*} = {e}^{j \frac{ω}{c} ( {L}_{12} - {L}_{4} - {L}_{6} )} \approx {e}^{j \frac{ω}{c} ( - {L}_{4} )} \\ or \\ {( {B}_{inner , source} ( {t}_{2} ) )}^{*} \cdot {B}_{o u ter , sou r c e} ( {t}_{2} ) \approx {e}^{j \frac{ω}{c} ( {L}_{4} )} \qquad$$

The Sᵢ components, which go through both inner and outer measures are cancelled out due to the conjugate multiplication.

Another means to obtain L₄, using the exciter only:

$${B}_{outer , exc} ( {t}_{2} ) \cdot {( {B}_{inner , exc} ( {t}_{2} ) )}^{*} = {e}^{j \frac{ω}{c} ( {L}_{12} - {L}_{4} - {L}_{6} )} \\ {B}_{outer , exc} ( {t}_{2} ) \cdot {( {B}_{inner , exc} ( {t}_{2} ) )}^{*} = {e}^{j \frac{ω}{c} ( {L}_{1} ( {t}_{i} ) + {L}_{2} + {L}_{3} + {L}_{4} + {L}_{6} + {L}_{7} + {L}_{8} + {L}_{9} + {L}_{10} ( {t}_{i} ) )} \cdot {e}^{- j \frac{ω}{c} ( {L}_{1} ( {t}_{i} ) + {L}_{2} + {L}_{3} + {L}_{12} + {L}_{7} + {L}_{8} + {L}_{9} + {L}_{10} ( {t}_{i} ) )} = {e}^{j \frac{ω}{c} ( {L}_{4} + {L}_{6} - {L}_{12} )} = {e}^{j \frac{ω}{c} ( {L}_{4} )} \\ Thus \\ {B}_{i n ner , sou r c e} ( {t}_{2} ) \cdot {( {B}_{o u ter , sou r c e} ( {t}_{2} ) )}^{*} = {B}_{o u t e r , e x c} ( {t}_{2} ) \cdot {( {B}_{i n ner , exc} ( {t}_{2} ) )}^{*} \qquad$$

Thus either of these can be used to obtain L₄.

So far, we have: L₁(t), L₂, L₃, and L₄.

To get L₅ and aᵢ(θ):

$$Receive Path ( {t}_{1} ) \cdot {( {B}_{inner , source} ( {t}_{1} ) )}^{*} = {e}^{j \frac{ω}{c} ( {a}_{i} ( θ ) + {L}_{5} + {L}_{6} - {L}_{3} - {L}_{12} - {S}_{1} )}$$

However, L₆ and L₁₂ are similar from channel to channel, via exact length traces on a PCB, so

$$Receive Path ( {t}_{1} ) \cdot {( {B}_{inner , source} ( {t}_{1} ) )}^{*} = {e}^{j \frac{ω}{c} ( {a}_{i} ( θ ) + {L}_{5} - {L}_{3} - {S}_{1} )}$$

Therefore, using:

$${B}_{j} \approx T D {R}_{source} ( {t}_{2} ) \approx {e}^{j \frac{ω}{c} ( {S}_{1} + {L}_{3} )}$$

$$Then$$

$$Receive Path ( {t}_{1} ) \cdot {( {B}_{inner , source} ( {t}_{1} ) )}^{*} \cdot {TDR}_{source} ( {t}_{2} ) \approx {e}^{j \frac{ω}{c} ( {a}_{i} ( θ ) + {L}_{5} )}$$

Putting this all together, and using:

a) The stored Bj or TDR_{source} measurement, at time t₀.

b) The Receive Path measurement, at time t₁

c) The B_{inner,source} measurement, at time t₂ or after

d) The B_{inner,exciter} measurement, at time t₂ or after

e) The B_{outer,source} measurement, at time t₂ or after

The Forward (Transmit) path weights can then be computed as:

$$\underline{w} = \frac{\begin{matrix}{B}_{inner , exc} ( {t}_{2} ) \cdot {TDR}_{source} ( {t}_{0} ) \cdot {B}_{outer , source} ( {t}_{2} ) \cdot \\ Receive Path ( {t}_{1} ) \cdot {TDR}_{source} ( {t}_{0} )\end{matrix}}{{B}_{inner , source} ( {t}_{2} ) \cdot {B}_{inner , source} ( {t}_{2} ) \cdot {B}_{inner , source} ( {t}_{1} )} = \frac{Receive Path ( {t}_{1} )}{{B}_{inner , source} ( {t}_{1} )} \cdot \frac{{B}_{outer , source} ( {t}_{2} )}{{B}_{inner , source} ( {t}_{2} )} \cdot \frac{{B}_{inner , exc} ( {t}_{2} )}{{B}_{inner , source} ( {t}_{2} )} \cdot {TDR}_{source} ( {t}_{0} ) \cdot {TDR}_{source} ( {t}_{0} ) = {a}_{cal} ( θ ) \cdot \frac{{B}_{outer , source} ( {t}_{2} )}{{B}_{inner , source} ( {t}_{2} )} \cdot \frac{{B}_{inner , exc} ( {t}_{2} )}{{B}_{inner , source} ( {t}_{2} )} \cdot {TDR}_{source} ( {t}_{0} ) \cdot {TDR}_{source} ( {t}_{0} ) = {a}_{cal} ( θ ) \cdot \frac{{B}_{outer , source} ( {t}_{2} )}{{B}_{inner , source} ( {t}_{2} )} \cdot \frac{{B}_{inner , exc} ( {t}_{2} )}{{B}_{inner , source} ( {t}_{2} )} \cdot {B}_{j} \cdot {B}_{j} = \frac{{e}^{j \frac{ω}{c} ( {a}_{i} ( θ ) + {L}_{5} + {L}_{6} )}}{{e}^{j \frac{ω}{c} ( {S}_{i} + {L}_{3} + {L}_{12} )}} {e}^{j \frac{ω}{c} ( {L}_{4} )} {e}^{j \frac{ω}{c} ( {L}_{1} ( {t}_{2} ) + {L}_{2} - {S}_{1} )} {e}^{j \frac{ω}{c} ( {S}_{1} + {L}_{3} )} {e}^{j \frac{ω}{c} ( {S}_{1} + {L}_{3} )} = {e}^{j \frac{ω}{c} ( {L}_{1} ( {t}_{2} ) + {L}_{2} + {L}_{3} + {L}_{4} + {L}_{5} + {a}_{i} ( θ ) )} \qquad$$

Which is the full forward path, at time t₂, or near t₂; assuming that the initial transceiver random phase, for each channel, is stationary. All of the Sᵢ components have also cancelled out, thus with the given Direct Measurement method, or TDR compensation method, it is not necessary to have any phase matching of Sᵢ paths.

Using the four (4) different boresighting paths, and their representative steering vectors, enables us to obtain a perfect replica of the desired forward (or Transmit) path delay from the DAC (103) through the antenna (110) and including the far field antenna-to-target delay:

$$Transmit Path = {e}^{j \frac{ω}{c} ( {L}_{1} ( {t}_{2} ) + {L}_{2} + {L}_{3} + {L}_{4} + {L}_{5} + {a}_{i} ( θ ) )}$$

An alternative method is:

a) The stored Bⱼ or TDRsource measurement, at time t₀.

b) The Receive Path measurement, at time t₁

c) The B_{inner,source} measurement, at time t₂ or after

d) The B_{inner,exciter} measurement, at time t₂ or after

e) The B_{outer,exciter} measurement, at time t₂ or after

$$\underline{w} = \frac{\begin{matrix}{B}_{inner , exc} ( {t}_{2} ) \cdot {TDR}_{source} ( {t}_{0} ) \cdot {B}_{outer , source} ( {t}_{2} ) \cdot \\ Receive Path ( {t}_{1} ) \cdot {TDR}_{source} ( {t}_{0} )\end{matrix}}{{B}_{inner , source} ( {t}_{2} ) \cdot {B}_{inner , source} ( {t}_{2} ) \cdot {B}_{inner , source} ( {t}_{1} )} = \frac{Receive Path ( {t}_{1} )}{{B}_{inner , source} ( {t}_{1} )} \cdot \frac{{B}_{outer , source} ( {t}_{2} )}{{B}_{inner , source} ( {t}_{2} )} \cdot \frac{{B}_{inner , exc} ( {t}_{2} )}{{B}_{inner , source} ( {t}_{2} )} \cdot {TDR}_{source} ( {t}_{0} ) \cdot {TDR}_{source} ( {t}_{0} ) = {a}_{cal} ( θ ) \cdot \frac{{B}_{outer , exc} ( {t}_{2} )}{{B}_{inner , exc} ( {t}_{2} )} \cdot \frac{{B}_{inner , exc} ( {t}_{2} )}{{B}_{inner , source} ( {t}_{2} )} \cdot {TDR}_{source} ( {t}_{2} ) \cdot {TDR}_{source} ( {t}_{2} ) = {a}_{cal} ( θ ) \cdot \frac{{B}_{outer , exc} ( {t}_{2} )}{{B}_{inner , source} ( {t}_{2} )} \cdot {TDR}_{source} ( {t}_{2} ) \cdot {TDR}_{source} ( {t}_{2} ) = \frac{{e}^{j \frac{ω}{c} ( {a}_{i} ( θ ) + {L}_{5} )}}{{e}^{j \frac{ω}{c} ( {S}_{1} + {L}_{3} )}} \frac{{e}^{j \frac{ω}{c} ( {L}_{1} ( {t}_{i} ) + {L}_{2} + {L}_{3} + {L}_{4} + {L}_{7} + {L}_{8} + {L}_{9} + {L}_{10} ( {t}_{i} ) )}}{{e}^{j \frac{ω}{c} ( {S}_{1} + {L}_{3} + {L}_{7} + {L}_{8} + {L}_{9} + {L}_{10} ( {t}_{i} ) )}} {e}^{j \frac{ω}{c} ( {S}_{1} + {L}_{3} )} {e}^{j \frac{ω}{c} ( {S}_{1} + {L}_{3} )} = {e}^{j \frac{ω}{c} ( {L}_{1} ( {t}_{2} ) + {L}_{2} + {L}_{3} + {L}_{4} + {L}_{5} + {a}_{i} ( θ ) )} \qquad$$

For very high SNR signals, it is not necessary to perform Eigen-based autocorrelation and Eigen decomposition to obtain steering vectors.

### REFERENCES (INCORPORATED HEREIN BY REFERENCE)

Judd, M. (2018) U.S. patent Ser. No. 10/185,022

What is claimed is:

1. A system that compensates and corrects for unknown path delay and amplitude changes in the forward path from a transmitter circuit through to the Radio frequency (RF) antenna, into the RF far field, in real time comprising:
a multiplicity of primary circuit loops from the RF exciter to the antenna and back towards the receiver circuit paths,
an RF coupler in the receive path,
an RF switch near the antenna that switches between inner and outer boresighting paths,
a multiplicity of independent input sources including the internal exciter source as well as an external common RF source, which is split into a multiplicity of RF circuit paths, one for each RF channel,
whereas each RF source is coherent among all antennas in an array, and
wherein either a multichannel or single channel system can be used.

2. The system of claim 1 wherein the multiplicity of circuit loops provides signaling paths that are used to compute and calibrate each path length segment of the full system including path lengths, or time delays, from the RF exciter out to the RF radiated far field beam line, as well as including paths from the Antennas to each receiver, and for RF cables or transmission lines from an RF Transceiver system to a Forward Error Correction (FEC) Unit.

3. The system of claim 1 in which a total path length, or steering weight, from the Digital to Analog Converter within the RF exciter or transmitter to the far field power combining beam line, is unknown prior to FEC system calibration and boresighting, therefore while the FEC technique corrects for all phase and amplitude variations and changes in the system, it also corrects for non-equal length RF cables from the RF exciter or transmitter to both the antenna and the radiated far field beam line.

4. The system of claim 1 wherein all phase and amplitude variations and changes in the system, for both the forward path from the RF exciter or transmitter into the radiated far field or far field beam line, are corrected, including phase and/or amplitude differences in non-equal length RF cables, removing any requirement for phased matched cables in an array system, and assuring RF coherency and beam steering ability to a far field point or far field beam line.

5. The system of claim 1 wherein a set of complex array weights is produced for each frequency, such that with knowledge of the far field complex steering vector obtained from using a far field RF source during receive calibration, that RF transmission into the radiated far field can be effectively emulated as a planar array to the beam line in the far field with completely known antenna phase centers, from an arbitrary multiplicity of antennas in arbitrary and non-exactly known locations and orientations and with RF cables or transmission lines that are unknown in length or unmeasured in phase.

6. The system of claim 1 wherein prior to first use, an internal bore-sight calibration in which RF signals are injected into each and every loop, is performed to compute the receive path delay and amplitude perturbation steering vector, using simultaneously measured far field receive vector phase and amplitude data from an external far field RF source, and a boresight vector representing the inner loop and the internal or external source is measured simultaneously.

7. The system of claim 1 wherein during initial system calibration, using an external far field RF source, the receive path steering vector and the bore inner source steering vectors are generated at the same time, and use either snapshot-by-snapshot boresighting or covariance boresighting to generate, via phase unwrapping and phase & amplitude interpolation, a calibration table or array manifold which includes the boresighted correction phases obtained through the inner boresight measurement.

8. The system of claim 1 wherein each bore-sighting measurement steering vector for each and every loop, using either the exciter RF source or external RF source, is computed through sampling of a representative path and integrating samples to produce an averaged vector resultant, which is obtained through collection of channel time samples, and formation of a sampled covariance matrix, decomposition, and selection of an eigenvector associated with a dominant eigenvalue.

9. The system of claim 1 wherein the plurality of multiple RF circuit loops and the plurality of independent internal and external RF sources provides multiple different loop-source paths, including a bore inner source, a bore inner exciter, a bore outer source, and a bore outer exciter, each that are measured, and produce a set of multiple distinct array steering vectors comprising multiple different paths which all go through the FEC antenna unit and are denoted as inner and outer RF paths, which include the unknown path lengths of the RF transmission lines from the RF Exciter or Transmitter to the radiating antennas, in reference to a particular loop path chosen.

10. The system of claim 1 wherein use of multiple distinct loop RF source boresighting paths, the use of a Far Field radiating source to generate a receive path steering vector, and other representative steering vectors, enables a generation of a perfect replica of a desired forward, or transmit, path delay and amplitude variations from the Digital to Analog Converters (DACs) in the RF exciter or transmitter through the antennas in the array, and including ft the radiated far field antenna-to-target delay point or far field beam line, therein representing a net path, or distance delays from the DACs through the RF exciter or transmitter and up through the antennas for a complete RF system, and all RF channels, that enable coherent RF power combining in the far field either along a desired steered beam line or to a single or multiplicity of points in the RF far field.

11. A method of constructing a system that compensates and corrects for unknown path delay and amplitude changes in the forward path from a transmitter circuit through to the RF antenna into the RF far field in real time comprising:
a multiplicity of primary circuit loops from the RF exciter to the antenna and back towards the receiver circuit paths.

12. The method of claim 11 wherein a multiplicity of independent input sources, including the internal exciter source as well as an external common RF source whereas each RF source is coherent among all antennas in the array within either a multichannel or signal channel system, which is split into a multiplicity of RF circuit paths, one for each RF channel, feeds to an RF switch added near the antenna that switches between inner and outer boresighting circuitry loops, which subsequently feeds to an RF coupler in the receive path.

13. The method of claim 12 wherein the multiplicity of RF circuit loops provides signaling paths that are used compute and calibrate each path length segment of the full system including the path lengths, or time delays, from the RF exciter out to the RF radiated far field beam line, as well as including paths from the Antennas to each receiver, and for the RF cables or transmission lines from the RF Transceiver system to the Forward Error Correction (FEC) Unit.

14. The method of claim 11 wherein the total path length, or steering weight, from the Digital to Analog Converter within the RF exciter or transmitter to the far field power combining beam line, is unknown prior to FEC system calibration and boresighting, therefore while the FEC technique corrects for all phase and amplitude variations and changes in the system, it also corrects for non-equal length RF cables from the RF exciter or transmitter to both the antenna and the radiated far field beam line.

15. The method of claim 14 wherein all phase and amplitude variations and changes in the system, for both the forward path from the RF exciter or transmitter into the radiated far field or far field beam line, are corrected, including phase and/or amplitude differences in non-equal length RF cables, removing any requirement for phased matched cables in the array system, and assuring RF coherency and beam steering ability to a far field point or far field beam line.

16. The method of claim 11 wherein a set of complex array weights is produced for each frequency, such that with knowledge of the far field complex steering vector obtained from using a far field RF source during receive calibration, that RF transmission into the radiated far field can be effectively emulated as a planar array to the beam line in the far field with completely known antenna phase centers, from an arbitrary multiplicity of antennas in arbitrary and non-exactly known locations and orientations and with RF cables or transmission lines that are unknown in length or unmeasured in phase.

17. The method of claim 13 wherein prior to first use, an internal boresight calibration in which RF signals are injected into each and every circuitry loop, is performed to compute the receive path delay and amplitude perturbation steering vector, using simultaneously measured far field receive vector phase and amplitude data from an external far field RF source, and the boresight vector representing the inner loop and the internal or external source is measured simultaneously.

18. The method of claim 17 wherein during initial system calibration using an external far field RF source, the receive path steering vector and the bore inner source steering vectors are generated at the same time, and use either snapshot-by-snapshot boresighting or covariance boresighting to generate, via phase unwrapping and phase & amplitude interpolation, a calibration table or array manifold which includes the boresighted correction phases obtained through the inner boresight measurement and wherein each bore-sighting measurement steering vector for each and every loop, using either the exciter RF source or external RF source, is computed through sampling of the representative path and integrating samples to produce an averaged vector resultant, which is obtained through collection of channel time samples, and formation of a sampled covariance matrix, decomposition, and selection of the eigenvector associated with the dominant eigenvalue.

19. The method of claim 13 wherein the plurality of multiple RF circuit loops and the plurality of independent internal and external RF sources provides multiple different loop-source paths, including a bore inner source, a bore inner exciter, a bore outer source, and a bore outer exciter, each that are measured, and produce a set of multiple distinct array steering vectors comprising multiple different paths which all go through the FEC antenna unit and are denoted as inner and outer RF paths, which include the unknown path lengths of the RF transmission lines from the RF exciter or transmitter to the radiating antennas, in reference to the particular loop path chosen.

20. The method of claim 17 wherein use of multiple distinct loop RF source boresighting paths, the use of a far field radiating source to generate a receive path steering vector, and other representative steering vectors, enables the generation of a perfect replica of the desired forward, or transmit, path delay and amplitude variations from the Digital to Analog Converters (DACs) in the RF exciter or transmitter through the antennas in the array, and including the radiated far field antenna-to-target delay point or far field beam line, therein representing the net path, or distance delays from the DACs through the RF exciter or transmitter and up through the antennas for the complete RF system, and all RF channels, that enable coherent RF power combining in the far field either along a desired steered beam line or to a single or multiplicity of points in the RF far field.
